(19) United States
(12) Patent Application Publication
(10) Pub. No.: US 2025/0052878 A1
(43) Pub. Date: Feb. 13, 2025

(54) Method And Apparatus For A Positioning Model Using Relative Time Input In Mobile Communications

(71) Applicant: MediaTek Singapore Pte. Ltd., Singapore (SG)

(72) Inventors: Mingwei Jie, Shanghai (CN); Pengli Yang, Shanghai (CN); Rao Dai, Shanghai (CN); Chiao-Yao Chuang, Hsinchu City (TW); Xuancheng Zhu, Shanghai (CN)

(21) Appl. No.: 18/795,123

(22) Filed: Aug. 5, 2024

(30) Foreign Application Priority Data
Aug. 10, 2023 (WO) PCT/CN2023/112305
Jul. 25, 2024 (CN) 202411008601.7

(51) Int. Cl. G01S 11/02; H04L 25/02; H04W 56/00; H04W 64/00

(52) U.S. Cl. CPC G01S 11/02; H04L 25/0212; H04W 56/0055; H04W 64/006

(57) ABSTRACT

Various solutions for an artificial intelligence/machine learning (AI/ML) positioning model using relative time input with respect to an apparatus in mobile communications are described. The apparatus may measure a first channel delay profile with a first path timing according to a first reference signal associated with a first network node. The apparatus may adjust the first path timing by a timing difference associated with a reference network node. The apparatus may: (1) generate a model output by a positioning model based on the first channel delay profile with the adjusted first path timing used as model inputs; or (2) report the first channel delay profile with the adjusted first path timing to a network.

### CROSS REFERENCE TO RELATED PATENT APPLICATION(S)

The present disclosure is part of a non-provisional application claiming the priority benefit of PCT Application No. PCT/CN2023/112305, filed 10 Aug. 2023, and CN application No. 202411008601.7, filed 25 Jul. 2024. The contents of aforementioned applications are herein incorporated by reference in their entirety.

### TECHNICAL FIELD

The present disclosure is generally related to mobile communications and, more particularly, to an artificial intelligence/machine learning (AI/ML) positioning model using relative time input with respect to apparatus in mobile communications.

### BACKGROUND

Unless otherwise indicated herein, approaches described in this section are not prior art to the claims listed below and are not admitted as prior art by inclusion in this section.

In 5th-generation (5G) New Radio (NR) mobile communications, artificial intelligence (AI)/machine learning (ML) schemes are introduced to position an apparatus. In particular, AI/ML-based positioning may involve training data collection, model training, model inference and model performance monitoring. By using a trained AI/ML positioning model with some model input data, the position of a user equipment (UE) may be appropriately estimated.

However, the model input data may directly impact positioning performance/accuracy and signaling overhead throughout the model lifecycle management. Thus, the format of model input data may be a crucial topic in AI/ML positioning. Therefore, there is a need to provide proper format of model input data for AI/ML positioning.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

An objective of the present disclosure is to propose solutions or schemes that using relative time as model input of an artificial intelligence/machine learning (AI/ML) positioning model with respect to apparatus in mobile communications.

In one aspect, a method may involve an apparatus measuring a first channel delay profile with a first path timing according to a first reference signal associated with a first network node. The method may also involve the apparatus adjusting the first path timing by a timing difference associated with a reference network node. The method may further involve the apparatus: (1) generating a model output by a positioning model based on the first channel delay profile with the adjusted first path timing used as model inputs; or (2) reporting the first channel delay profile with the adjusted first path timing to a network.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising measuring, via the transceiver, a first channel delay profile with a first path timing according to a first reference signal associated with a first network node. The processor may also perform operations comprising adjusting the first path timing by a timing difference associated with a reference network node. The processor may further perform operations comprising: (1) generating a model output by a positioning model based on the first channel delay profile with the adjusted first path timing used as model inputs; or (2) reporting via the transceiver, the first channel delay profile with the adjusted first path timing to a network.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting example scenarios under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a block diagram of an example communication system in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to an artificial intelligence/machine learning (AI/ML) positioning model using relative time input with respect to apparatus in mobile communications. According to the present disclosure, a number of possible solutions may be implemented separately or jointly. That is, although these possible solutions may be described below separately, two or more of these possible solutions may be implemented in one combination or another.

Regarding to AI/ML positioning model of the present disclosure, model inputs with relative time may be introduced to enhance the accuracy of model outputs. In particular, a network may notify a user equipment (UE) of a reference network node. The UE may measure a channel delay profile with multiple path timings based on one or more reference signals (e.g., downlink-positioning reference signals (DL-PRSs) transmitted from one or more target network nodes (e.g., target transmission reception point (TRPs)). More specifically, after the one or more target network nodes transmit the reference signals, the UE may receive the reference signals via multiple paths at different path timings, and then measure the channel delay profile based on the reference signals. For each path timing, the UE may use a timing difference associated with the reference network node as a base, and adjust each path timing by the timing difference.

Then, for UE-based AI/ML positioning model (i.e., the AI/ML positioning model is utilized at UE end) the UE may generate model output by the AI/ML positioning model based on the channel delay profile with the adjusted path timings used as model inputs. In other words, the UE may input the channel delay profile with the adjusted path timings into the AI/ML positioning model for generating the model output such as UE position. For UE-assisted AI/ML positioning model (i.e., the AI/ML positioning model is utilized at network) the UE may report the channel delay profile with the adjusted path timings to network so that the network may determine the model output by the positioning model based on the channel delay profile with the adjusted path timings used as the model inputs. In other words, after receiving channel delay profile with the adjusted path timings, the network may input the channel delay profile with the adjusted path timings into the AI/ML positioning model for generating the model output such as UE position.

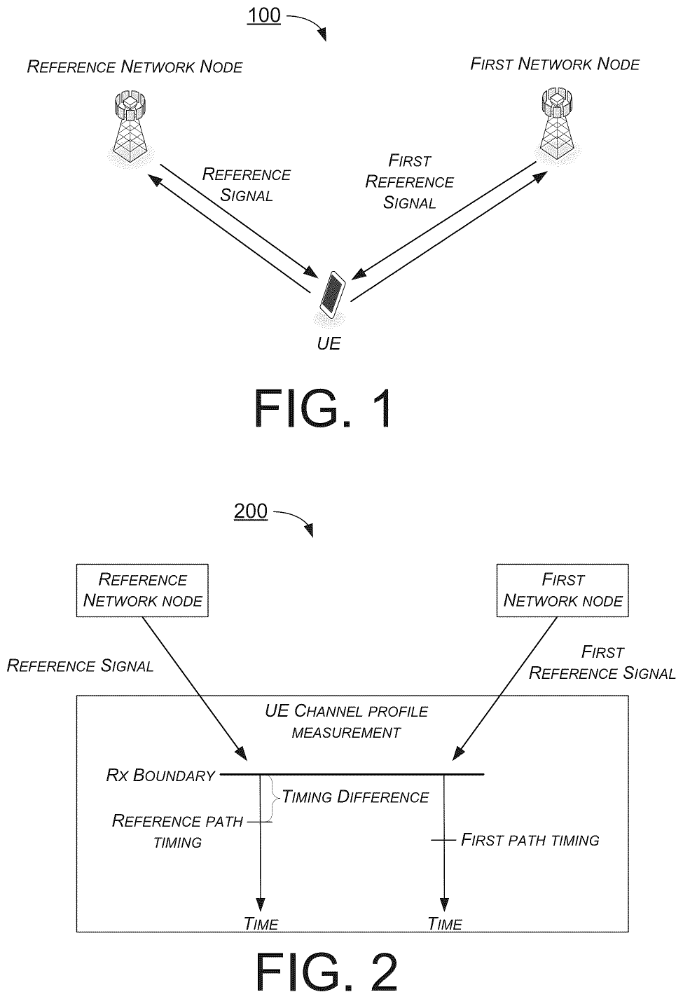

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates a current network framework in which UE may connect to the network nodes. In some implementations, the UE may include a positioning reference unit (PRU) and the network nodes may include TRPs. The network may notify the UE of which one is a reference network node.

FIG. 2 illustrates an example scenario 200 under schemes in accordance with implementations of the present disclosure. In some embodiments, the UE may measure a reference channel delay profile with a reference path timing according to a reference signal associated with the reference network node. In particular, the reference network node may transmit the reference signal (e.g., downlink-positioning reference signal (DL-PRS)) to the UE. The UE may receive the reference signal via a path at the reference path timing and measure a reference channel delay profile according to the reference signal. The UE may determine a timing difference as a difference between the reference path timing and a receiving boundary (i.e., Rx boundary indicating t=0). In some cases, the Rx boundary is a starting timing of a time interval of the channel delay profile inferred by the UE based on some signals. After determining the timing difference, the timing difference associated with the reference network node may be used as a base for determining relative time.

Further, the UE may measure a first channel delay profile with a first path timing according to a first reference signal associated with the first network node. In particular, the first network node may transmit the first reference signal to the UE. The UE may receive the first reference signal via a path at the first path timing and measure the first channel delay profile according to the first reference signal. Then, the UE may adjust the first path timing by the timing difference. After adjusting the first path timing, the UE may: (1) regarding UE-based AI/ML positioning model, generate a model output by an AI/ML positioning model based on the first channel delay profile with the adjusted first path timing used as model inputs; or (2) regarding UE-assisted positioning model, report the first channel delay profile with the adjusted first path timing to the network for the network to determine the model output by the AI/ML positioning model. In some cases, the channel delay profile may include at least one of channel impulse response (CIR), a power delay profile (PDP) and delay profile (DP).

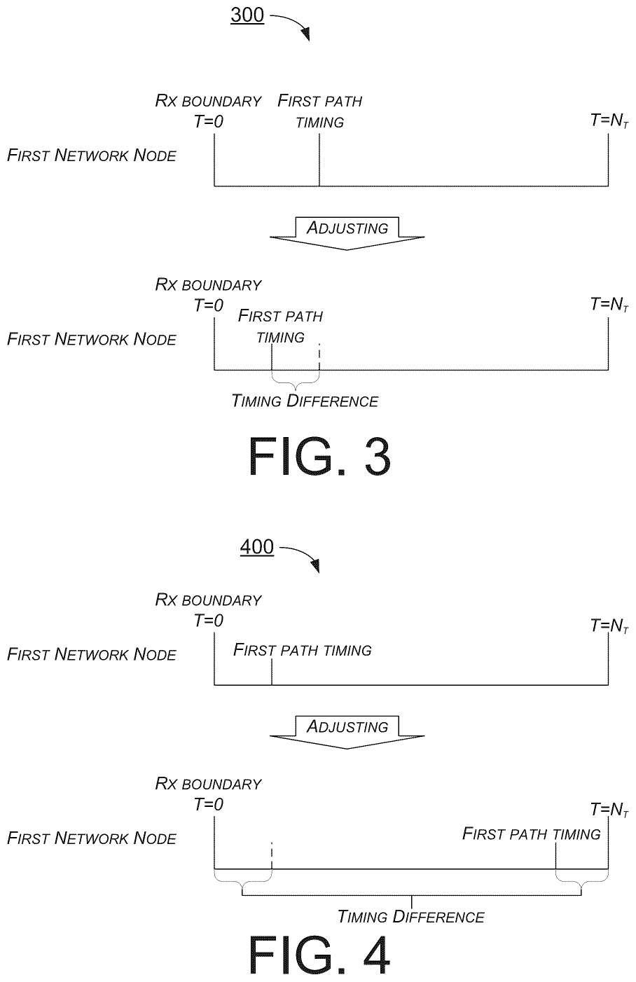

FIG. 3 illustrates an example scenario 300 under schemes in accordance with implementations of the present disclosure. In some implementations, a time interval (i.e., time domain samples) corresponding to the first channel delay profile may be from T=0 (Rx boundary) to T=Nₜ−1. When the reference path timing is earlier than the first path timing in the time interval, adjusting the first path timing by the timing difference may include shifting the first path timing by the timing difference. More specifically, shifting the first path timing by the timing difference may include advancing the first path timing by the timing difference. For example, when the first path timing is X and the time difference is Y, the adjusting first path timing equals a value obtained by subtracting Y from X (i.e., the adjusting first path timing is (X−Y)).

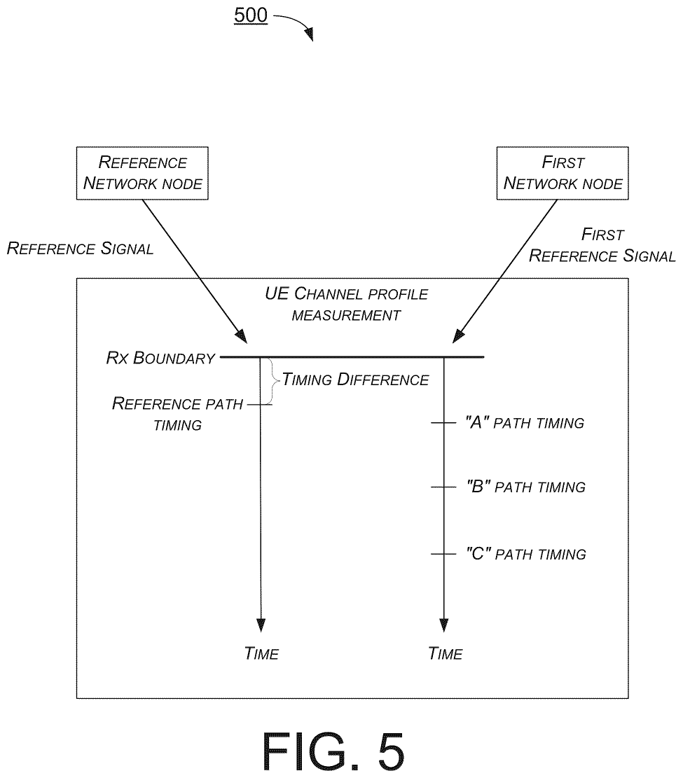

FIG. 4 illustrates an example scenario 400 under schemes in accordance with implementations of the present disclosure. In some implementations, the time interval (i.e., time domain samples) corresponding to the first channel delay profile may be from T=0 (Rx boundary) to T=Nₜ. When the reference path timing is later than the first path timing in the time interval, adjusting the first path timing by the timing difference may include shifting the first path timing by the timing difference circularly in a time interval. For example, when the first path timing is A and the time difference is B, the adjusting first path timing equals a value obtained by subtracting B from A and adding Nₜ (i.e., the adjusting first path timing is (A−B+Nₜ).

In some embodiments, before putting the AI/ML positioning model to use, the AI/ML positioning model may need to be trained by some training data. In particular, the AI/ML positioning model may be generated (e.g., at network or UE end) with a plurality of pairs of training model inputs and training model outputs according to some machine learning schemes. Each training model input may include a training channel delay profile with at least one training path timing adjusted by a training time difference. For example, each of some of the training model inputs includes one training channel delay profile with one training path timing adjusted by the training time difference, and each of some of the training model inputs includes one training channel delay profile with multiple training path timings all adjusted by the training time difference. Each training model output may include a training position. Accordingly, after training, the AI/ML positioning model may receive a channel delay profile with at least one path timing adjusted by a time difference, and then generate a position.

FIG. 5 illustrates an example scenario 500 under schemes in accordance with implementations of the present disclosure. In some embodiments, the UE may measure a reference channel delay profile with a reference path timing according to a reference signal associated with the reference network node. In particular, the reference network node may transmit the reference signal to the UE. The UE may receive the reference signal via a path at the reference path timing and measure a reference channel delay profile according to the reference signal. The UE may determine a timing difference as a difference between the reference path timing and a Rx boundary. After determining the timing difference, the timing difference associated with the reference network node may be used as a base for determining relative time.

Further, the UE may measure a first channel delay profile with a plurality of path timings (i.e., “A” path timing, “B” path timing and “C” path timing shown in FIG. 5) according to a first reference signal associated with the first network node. In particular, the first network node may transmit the first reference signal to the UE. The UE may receive the first reference signal via a plurality of paths (e.g., line-of-sight (LOS) path or non-LOS (NLOS path)) at different path timings (i.e., “A” path timing, “B” path timing and “C” path timing shown in FIG. 5) and measure the first channel delay profile according to the first reference signal. Then, for each path timing, the UE may adjust the path timing by the timing difference. After adjusting the path timings, the UE may: (1) regarding UE-based AI/ML positioning model, generate a model output by an AI/ML positioning model based on the first channel delay profile with the adjusted path timings used as model inputs; or (2) regarding UE-assisted positioning model, report the first channel delay profile with the adjusted path timings to the network for the network to determine the model output by the AI/ML positioning model.

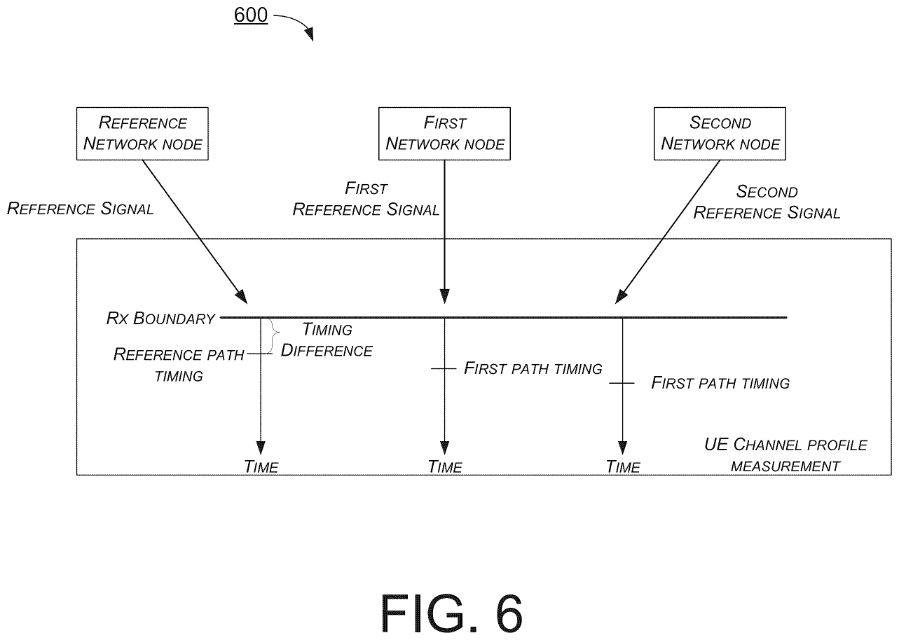

FIG. 6 illustrates an example scenario 600 under schemes in accordance with implementations of the present disclosure. In some embodiments, the UE may measure a reference channel delay profile with a reference path timing according to a reference signal associated with the reference network node. In particular, the reference network node may transmit the reference signal to the UE. The UE may receive the reference signal via a path at the reference path timing and measure a reference channel delay profile according to the reference signal. The UE may determine a timing difference as a difference between the reference path timing and a Rx boundary. After determining the timing difference, the timing difference associated with the reference network node may be used as a base for determining relative time.

Further, the UE may: (1) measure a first channel delay profile with a first path timing associated with a first network node according to a first reference signal associated with the first network node; and (2) measure a second channel delay profile with a first path timing associated with a second network node according to a second reference signal associated with the second network node. In particular, the first network node may transmit the first reference signal to the UE. The UE may receive the first reference signal via a path at the first path timing associated with the first network node and measure the first channel delay profile according to the first reference signal. Then, the UE may adjust the first path timing associated with the first network node by the timing difference. The second network node may transmit the second reference signal to the UE. The UE may receive the second reference signal via a path at the first path timing associated with the second network node and measure the second channel delay profile according to the second reference signal. Then, the UE may adjust the first path timing associated with the second network node by the timing difference.

After adjusting the first path timings, the UE may: (1) regarding UE-based AI/ML positioning model, generate a model output by an AI/ML positioning model based on the first channel delay profile with the adjusted first path timing associated with the first network node and the second channel delay profile with the adjusted first path timing associated with the second network node used as model inputs; or (2) regarding UE-assisted positioning model, report the first channel delay profile with the adjusted first path timing associated with the first network node and the second channel delay profile with the adjusted first path timing associated with the second network node to the network for the network to determine the model output by the AI/ML positioning model.

### Illustrative Implementations

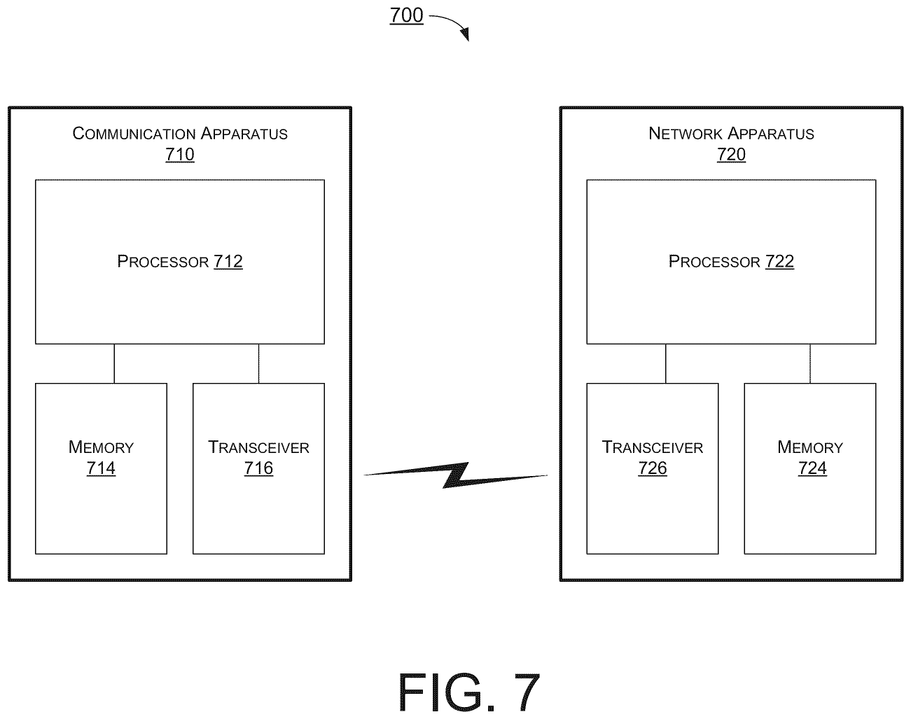

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to an AI/ML positioning model using relative time input with respect to user equipment and network apparatus in mobile communications, including scenarios/schemes described above as well as process 800 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a satellite, a base station, a small cell, a router or a gateway. For instance, network apparatus 720 may be implemented in an eNodeB in an LTE network, in a gNB in a 5G/NR, IoT, NB-IoT or IIoT network or in a satellite or base station in a 6G network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including AI/ML positioning model using relative time input in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, communication apparatus 710 may further include a memory 714 coupled to processor 712 and capable of being accessed by processor 712 and storing data therein. In some implementations, network apparatus 720 may also include a transceiver 726 coupled to processor 722 and capable of wirelessly transmitting and receiving data. In some implementations, network apparatus 720 may further include a memory 724 coupled to processor 722 and capable of being accessed by processor 722 and storing data therein. Accordingly, communication apparatus 710 and network apparatus 720 may wirelessly communicate with each other via transceiver 716 and transceiver 726, respectively. To aid better understanding, the following description of the operations, functionalities and capabilities of each of communication apparatus 710 and network apparatus 720 is provided in the context of a mobile communication environment in which communication apparatus 710 is implemented in or as a communication apparatus or a UE and network apparatus 720 is implemented in or as a network node (e.g., a TRP) of a communication network.

### Illustrative Processes

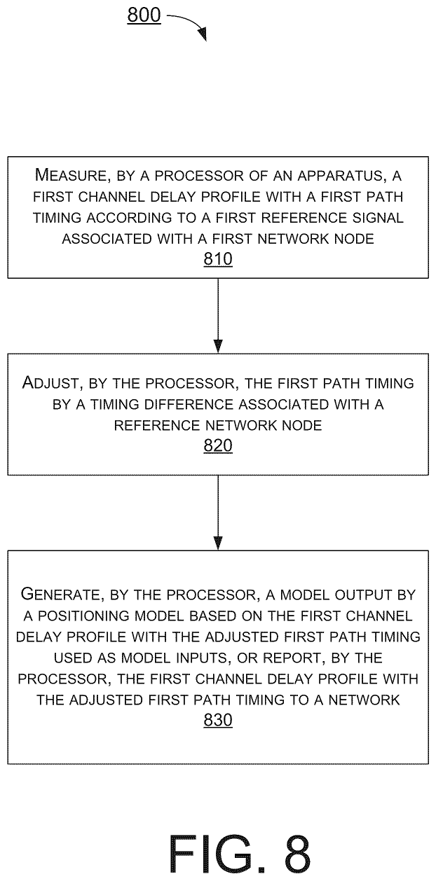

FIG. 8 illustrates an example process 800 in accordance with an implementation of the present disclosure. Process 800 may be an example implementation of above scenarios/schemes, whether partially or completely, with respect to an AI/ML positioning model using relative time input of the present disclosure. Process 800 may represent an aspect of implementation of features of communication apparatus 710. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE or machine type devices. Solely for illustrative purposes and without limitation, process 800 is described below in the context of communication apparatus 710. Process 800 may begin at block 810.

At block 810, process 800 may involve processor 712 of communication apparatus 710 measuring a first channel delay profile with a first path timing according to a first reference signal associated with a first network node. Process 800 may proceed from block 810 to block 820.

At block 820, process 800 may involve processor 712 of communication apparatus 710 adjusting the first path timing by a timing difference associated with a reference network node. Process 800 may proceed from block 820 to block 830.

At block 830, process 800 may involve processor 712 of communication apparatus 710: (1) generating a model output by a positioning model based on the first channel delay profile with the adjusted first path timing used as model inputs; or (2) reporting the first channel delay profile with the adjusted first path timing to a network.

In some implementations, process 800 may further involve processor 712 of communication apparatus 710 measuring a reference channel delay profile with a reference path timing according to a reference signal associated with the reference network node. Process 800 may further involve processor 712 of communication apparatus 710 determining the timing difference as a difference between the reference path timing and a receiving boundary.

In some implementations, process 800 may further involve processor 712 of communication apparatus 710 shifting the first path timing by the timing difference associated with the reference network node.

In some implementations, process 800 may further involve processor 712 of communication apparatus 710 shifting the first path timing by the timing difference associated with the reference network node circularly in a time interval.

In some implementations, process 800 may further involve processor 712 of communication apparatus 710 generating the positioning model with a plurality of pairs of training model inputs and training model outputs according to a machine learning scheme, wherein each training model input includes a training channel delay profile with at least one training path timing adjusted by a training time difference, and each training model output includes a training position.

In some implementations, process 800 may further involve processor 712 of communication apparatus 710 measuring the first channel delay profile with the first path timing associated with the first network node and a second path timing associated with the first network node according to the first reference signal associated with the first network node. Process 800 may further involve processor 712 of communication apparatus 710 adjusting the first path timing and the second path timing by the timing difference associated with the reference network node. Process 800 may further involve processor 712 of communication apparatus 710: (1) generating the model output by the positioning model based on the first channel delay profile with the adjusted first path timing and the adjusted second timing used as model inputs; or (2) reporting the first channel delay profile with the adjusted first path timing and the adjusted second path timing to network for determining the model output by the positioning model.

In some implementations, process 800 may further involve processor 712 of communication apparatus 710 measuring a second channel delay profile with a first path timing associated with a second network node according to a second reference signal associated with the second network node. Process 800 may further involve processor 712 of communication apparatus 710 adjusting the first path timing associated with the second network node by the timing difference associated with the reference network node. Process 800 may further involve processor 712 of communication apparatus 710: (1) generating the model output by the positioning model based on the first channel delay profile with the adjusted first path timing associated with the first network node and the second channel delay profile with the adjusted first timing associated with the second network node used as model inputs; or (2) reporting the first channel delay profile with the adjusted first path timing associated with the first network node and the second channel delay profile with the adjusted first path timing associated with the second network node to network for determining the model output by the positioning model.

In some implementations, the first channel delay profile includes at least one of a CIR, a PDP and a DP.

In some implementations, the first reference signal includes a positioning reference signal.

In some implementations, the apparatus includes a PRU.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a processor of an apparatus, a first channel delay profile with a first path timing according to a first reference signal associated with a first network node;
adjusting, by the processor, the first path timing by a timing difference associated with a reference network node; and
generating, by the processor, a model output by a positioning model based on the first channel delay profile with the adjusted first path timing used as model inputs, or reporting, by the processor, the first channel delay profile with the adjusted first path timing to a network.

2. The method of claim 1, further comprising:
measuring, by the processor, a reference channel delay profile with a reference path timing according to a reference signal associated with the reference network node; and
determining, by the processor, the timing difference as a difference between the reference path timing and a receiving boundary.

3. The method of claim 1, wherein the step of adjusting the first path timing by the timing difference associated with the reference network node further comprises:
shifting, by the processor, the first path timing by the timing difference associated with the reference network node.

4. The method of claim 1, wherein the step of adjusting the first path timing by the timing difference associated with the reference network node further comprises:
shifting, by the processor, the first path timing by the timing difference associated with the reference network node circularly in a time interval.

5. The method of claim 1, further comprising:
generating, by the processor, the positioning model with a plurality of pairs of training model inputs and training model outputs according to a machine learning scheme, wherein each training model input includes a training channel delay profile with at least one training path timing adjusted by a training time difference, and each training model output includes a training position.

6. The method of claim 1, wherein the step of measuring the first channel delay profile with the first path timing according to the first reference signal associated with the first network node further comprises:
measuring, by the processor, the first channel delay profile with the first path timing associated with the first network node and a second path timing associated with the first network node according to the first reference signal associated with the first network node;
wherein the step of adjusting the first path timing by the timing difference associated with the reference network node further includes:
adjusting, by the processor, the first path timing and the second path timing by the timing difference associated with the reference network node;
wherein the step of generating the model output by the positioning model based on the first channel delay profile with the adjusted first path timing used as model inputs further comprises:
generating, by the processor, the model output by the positioning model based on the first channel delay profile with the adjusted first path timing and the adjusted second timing used as model inputs;
wherein the step of reporting the first channel delay profile with the adjusted first path timing to network for determining the model output by the positioning model further comprises:
reporting, by the processor, the first channel delay profile with the adjusted first path timing and the adjusted second path timing to network for determining the model output by the positioning model.

7. The method of claim 1, further comprising:
measuring, by the processor, a second channel delay profile with a first path timing associated with a second network node according to a second reference signal associated with the second network node;
adjusting, by the processor, the first path timing associated with the second network node by the timing difference associated with the reference network node;
wherein the step of generating the model output by the positioning model based on the first channel delay profile with the adjusted first path timing used as model inputs further comprises:
generating, by the processor, the model output by the positioning model based on the first channel delay profile with the adjusted first path timing associated with the first network node and the second channel delay profile with the adjusted first path timing associated with the second network node used as model inputs;
wherein the step of reporting the first channel delay profile and the adjusted first path timing to network for determining the model output by the positioning model further comprises:
reporting, by the processor, the first channel delay profile with the adjusted first path timing associated with the first network node and the second channel delay profile with the adjusted first path timing associated with the second network node to network for determining the model output by the positioning model.

8. The method of claim 1, wherein the first channel delay profile includes at least one of a channel impulse response (CIR), a power delay profile (PDP) and a delay profile (DP).

9. The method of claim 1, wherein the first reference signal includes a positioning reference signal.

10. The method of claim 1, wherein the apparatus includes a positioning reference unit.

11. An apparatus, comprising:
a transceiver which, during operation, wirelessly communicates with at least one network node; and
a processor communicatively coupled to the transceiver such that, during operation, the processor performs operations comprising:
measuring, via the transceiver, a first channel delay profile with a first path timing according to a first reference signal associated with a first network node;
adjusting the first path timing by a timing difference associated with a reference network node; and
generating a model output by a positioning model based on the first channel delay profile with the adjusted first path timing used as model inputs, or reporting via the transceiver, the first channel delay profile with the adjusted first path timing to a network.

12. The apparatus of claim 11, wherein, during operation, the processor further performs operations comprising:
measuring, via the transceiver, a reference channel delay profile with a reference path timing according to a reference signal associated with the reference network node; and
determining the timing difference as a difference between the reference path timing and a receiving boundary.

13. The apparatus of claim 11, wherein the operation of adjusting the first path timing by the timing difference associated with the reference network node further comprises:
shifting the first path timing by the timing difference associated with the reference network node.

14. The apparatus of claim 11, wherein the operation of adjusting the first path timing by the timing difference associated with the reference network node further comprises:
shifting the first path timing by the timing difference associated with the reference network node circularly in a time interval.

15. The apparatus of claim 11, wherein, during operation, the processor further performs operations comprising:
generating the positioning model with a plurality of pairs of training model inputs and training model outputs according to a machine learning scheme, wherein each training model input includes a training channel delay profile with at least one training path timing adjusted by a training time difference, and each training model output includes a training position.

16. The apparatus of claim 11, wherein the operation of measuring the first channel delay profile with the first path timing according to the first reference signal associated with the first network node further comprises:
measuring, via the transceiver, the first channel delay profile with the first path timing associated with the first network node and a second path timing associated with the first network node according to the first reference signal associated with the first network node;
wherein the operation of adjusting the first path timing by the timing difference associated with the reference network node further comprises:
adjusting the first path timing and the second path timing by the timing difference associated with the reference network node;
wherein the operation of generating the model output by the positioning model based on the first channel delay profile with the adjusted first path timing used as model inputs further comprises:
generating the model output by the positioning model based on the first channel delay profile with the adjusted first path timing and the adjusted second timing used as model inputs
wherein the operation of reporting the first channel delay profile with the adjusted first path timing to network for determining the model output by the positioning model further comprises:
reporting, via the transceiver, the first channel delay profile with the adjusted first path timing and the adjusted second path timing to network for determining the model output by the positioning model.

17. The apparatus of claim 11, wherein, during operation, the processor further performs operations comprising:
measuring, via the transceiver, a second channel delay profile with a first path timing associated with a second network node according to a second reference signal associated with the second network node;
adjusting the first path timing associated with the second network node by the timing difference associated with the reference network node;
wherein the operation of generating the model output by the positioning model based on the first channel delay profile with the adjusted first path timing used as model inputs further comprises:
generating the model output by the positioning model based on the first channel delay profile with the adjusted first path timing associated with the first network node and the second channel delay profile with the adjusted first path timing associated with the first network node used as model inputs;
wherein the operation of reporting the first channel delay profile and the adjusted first path timing to network for determining the model output by the positioning model further comprises:
reporting, via the transceiver, the first channel delay profile with the adjusted first path timing associated with the first network node and the second channel delay profile with the adjusted first path timing associated with the second network node to network for determining the model output by the positioning model.

18. The apparatus of claim 11, wherein the first channel delay profile includes at least one of a channel impulse response (CIR), a power delay profile (PDP) and a delay profile (DP).

19. The apparatus of claim 11, wherein the first reference signal includes a positioning reference signal.

20. The apparatus of claim 11, wherein the apparatus includes a positioning reference unit.
